(19) United States
(12) Patent Application Publication
(10) Pub. No.: US 2009/0138609 A1
(43) Pub. Date: May 28, 2009

(54) Method and Apparatus for Maintaining User Sessions Across User Devices and Portals

(75) Inventors: Steven E. Anderson, San Diego, CA (US); Wendell Sun, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/945,675

(22) Filed: Nov. 27, 2007

(51) Int. Cl. G06F 15/16

(52) U.S. Cl. 709/228

(57) ABSTRACT

Embodiments of the invention generally provide a method and apparatus for maintaining user sessions across user devices and portals. One embodiment of a method for maintaining a user session across a group including a plurality of user devices includes altering, at a first device in the group, a state of the user session, such that a new session state results and transferring the new session state from the first device to at least one of the other devices in the group.

### FIELD OF THE INVENTION

The present invention generally relates to distributed networks, and more particularly relates to maintaining user session states in distributed networks.

### BACKGROUND OF THE INVENTION

The Internet infrastructure is stateless with respect to client or host sessions. That is, not every element within the Internet contains a finite session state for which any other element of the Internet or any client is dependent. One exception to this general rule is Transport Control Protocol/Internet Protocol (TCP/IP), wherein the state of a TCP/IP connection is between two endpoints or hosts connected to the Internet. However, even in this case, the network itself (i.e., the Internet) is not aware of any endpoint device state.

The concept of maintaining user session state across physical or logical user devices or user portals is essential to support seamless mobility. “Seamless mobility”, with regard to distributed networks, is defined in accordance with three criteria: (1) easy, substantially uninterrupted access to information, entertainment, communications, monitoring, and control; (2) the ability to be connected anywhere, anytime to anything, with any service; and (3) continuity of experience across multiple spatial domains, devices, networks, protocols, and access points.

Therefore, there is a need in the art for a method and apparatus for maintaining user sessions over user devices and portals.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual diagram illustrating an exemplary network in which embodiments of the present invention may be implemented;

FIG. 2 is a schematic diagram illustrating an exemplary group state database for an exemplary group of user devices;

FIG. 3 is a flow diagram illustrating a first embodiment of a method for synchronizing a group state database across a group of devices;

FIG. 4 is a flow diagram illustrating a second embodiment of a method for synchronizing a group state database across a group of devices;

FIG. 5 is a flow diagram illustrating one embodiment of a method for registering devices as members of a group;

FIG. 6 is a conceptual diagram illustrating an exemplary network in which one or more sessions take place; and

FIG. 7 is a high level block diagram of the present session maintenance method that is implemented using a general purpose computing device.

To facilitate understanding, identical reference numerals have been used, where possible, to designate identical elements that are common to the figures.

### DETAILED DESCRIPTION

Embodiments of the invention generally provide a method and apparatus for maintaining user sessions over user devices and portals. In one embodiment, the session states of groups of client devices, and the states of services associated with the groups of devices, are maintained in a distributed fashion, within the client devices themselves. No centralized element of the network is required to contain any sessions or client session states associated with the devices.

Within the context of the present invention, a “session” is understood to refer to a connection between devices (e.g., peer-to-peer) or between a device and a service provider (e.g., client/group application server), wherein the devices and/or services involved are end points that agree to exchange information. Such a relationship may be established, for example, for making telephone calls (client device) or for viewing streaming video (server or client device). One-to-one, one-to-many, and many-to-many session connections may be supported.

Within the context of the present invention, a “group” is understood to refer to the participants of a session. More specifically, “group membership” is understood to refer to physical devices, logical devices, or device portals that are grouped based upon some criterion (e.g., owner, family, friend(s), enterprise, function, logical constraint, subscription, physical constraint, or any other agreed upon criterion). All participating devices in a group are aware of group membership at all times. In some embodiments, the users of the devices are also aware that their devices are part of the group or groups. Moreover, all devices are aware of the other devices in the group and can find other devices within the group using a directory service (e.g., a lightweight directory access protocol- or information management system-based service) within the network. Although group membership is initially synchronized between all members of the group and the centralized directory service, group membership may be synchronized directly between group members once the group members have located each other.

Within the context of the present invention, a “session state” is understood to refer to what a user (e.g., group member) is doing with regard to a particular session. For example, a session state of PLAY, STOP, or PAUSE could be associated with a session relating to a streaming video service, as well as the time of the state transition (e.g., Network Play Time (NPT) for video and audio). Session state is associated with a session and is known by all members of a group (and possibly also by an application server associated with the group). Information about any particular user and/or user associated with the session and session state, however, may be hidden by that user or any other user within the group if desired and permitted. Session state is shared between group members and is relevant to the session that is associated with the group. Thus, all members of a group will see a session state that is initiated by any other member of the group. Although session state is known to the group, session state is not required to be (but may be allowed to be) contained within any centralized or distributed part of the network.

Within the context of the present invention, “presence” is understood to refer to a group's awareness of the locations and/or activities of all members of the group. Awareness of presence enables the ability to know where a device is physically located and what network is providing transport.

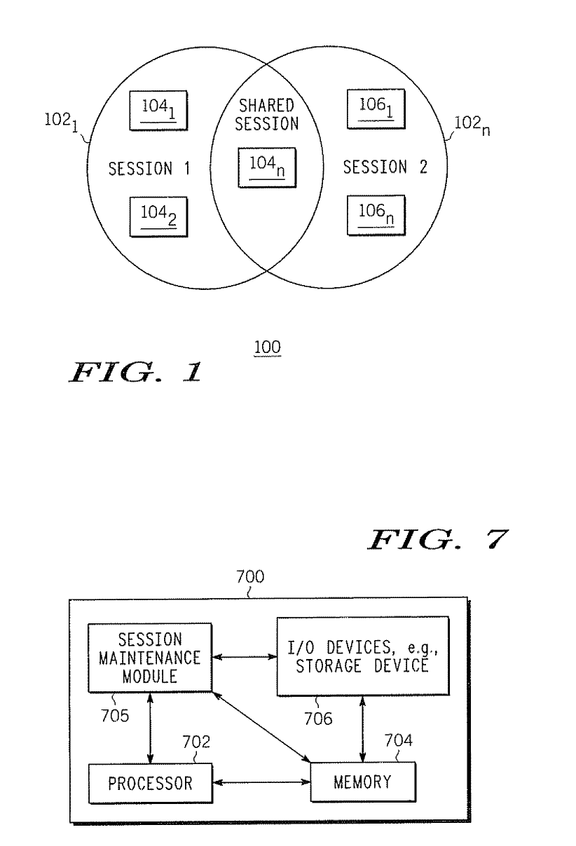

FIG. 1 is a conceptual diagram illustrating an exemplary network 100 in which embodiments of the present invention may be implemented. Within the network 100, one or more sessions 102₁-102ₙ (hereinafter collectively referred to as “sessions 102”) take place. In the illustrated embodiment, a first group of devices (or a mix of devices and applications) 104₁-104ₙ (hereinafter collectively referred to as “first group of devices 104”) participate in a first session 102₁ (e.g., a streaming video session), while a second group of devices (or a mix of devices and applications) 106₁-106ₙ (hereinafter collectively referred to as “second group of devices 106”) participate in a second session 102ₙ (e.g., a push-to-talk communication session). The first session 102₁ and the second session 102ₙ operate independently of each other.

Moreover, in the illustrated embodiment, device 104ₙ participates in both the first session 102₁ and the second session 102ₙ and thus may be viewed as a device that shares the state of the first session 102₁ and the state of the second session 102ₙ. The shared device 104ₙ may host both the first session 102₁ and the second session 102ₙ.

As discussed above, since the first group of devices 104 are all part of the same group, all of the devices in the first group of devices 104 share session state associated with any session activated by any one of the devices in the first group of devices 104. Thus, for example, if device 104₁ activates the first session 102₁, all of the devices in the first group of devices 104 will contain the first session's state. Likewise, all of the devices in the second group of devices 106 share session state for the second session 102ₙ. In one embodiment, session state and related information is shared by group members through the use of a synchronized group state database (GSDB).

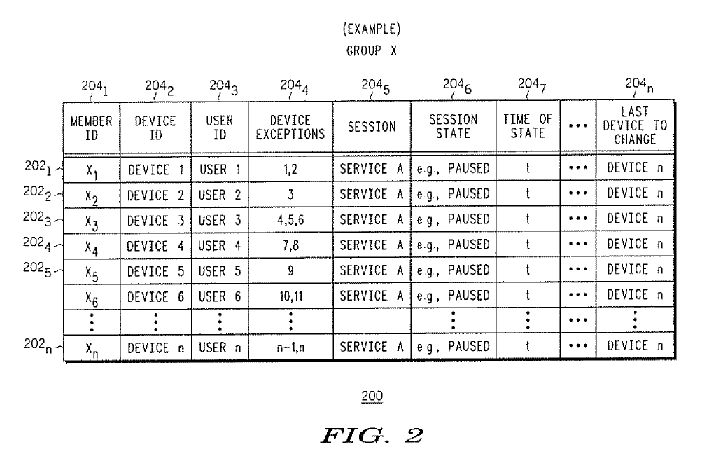

FIG. 2 is a schematic diagram illustrating an exemplary a group state database (GSDB) 200 for an exemplary group X of user devices. A GSDB contains current session state for a group with which the GSDB is associated. Every member of the group thus maintains an up-to-date, synchronized copy of the GSDB. That is, the local copies of the GSDB that are maintained by each member of the group are substantially identical.

As illustrated, the GSDB 200 contains a plurality of entries 202₁-202ₙ (hereinafter collectively referred to as “entries 202”), one entry 202 for each member of the group X. Each entry 202 in the GSDB 200 further comprises a plurality of fields 204₁-204ₙ (hereinafter collectively referred to as “fields 204”). Each field 204 contains up-to-date information regarding the member to which the entry 202 pertains. In one embodiment, an entry 202 includes a field 204 for at least one of: the member's group member ID (e.g., field 204₁), a device ID associated with the group member (e.g., field 204₂), a user ID of the member (e.g., field 204₃), device exceptions (preferences or rules) for the identified device (e.g., field 204₄), a session to which members of the group X are currently subscribed (e.g., field 204₅), and a current state of the session (e.g., field 204₆). In a further embodiment, an entry 202 also includes a field 204 for at least one of: a time (e.g., state transition time) as of which the session state went into effect (e.g., field 204₇), the last device in the group X to change the session state (e.g., field 204ₙ), a location of the identified device, and services that the identified device can render. The GSDB 200 illustrates only one example of how a GSDB according to the present invention may be arranged; other arrangements, comprising some or all of the fields 204 illustrated in the example, as well as fields not illustrated in the example, are contemplated.

For instance, suppose that a member host device n, associated with group member Xₙ, is engaged in a session with Service A, having a current session state of PAUSED as of time t. The service and session state, and in some cases the ID of the member host device n, will all be reflected in the local copies of the GSDB 200 at every other device that belongs to group X (i.e., devices 1 through n-1), as illustrated in fields 204₁-204ₙ. These devices may, in turn, indicate the service and session state to their respective users.

Referring again to FIG. 1, because device 104ₙ is shared by the first session 102₁ and the second session 102ₙ, device 104ₙ will acquire local copies of (and participate in) the GSDBs for both the first session 102₁ and the second session 102ₙ. As long as device 104ₙ participates in both the first group of devices 104 and the second group of devices 106, device 104ₙ will have awareness of all member devices of both the first group of devices 104 and the second group of devices 106. However, the respective GSDBs for the first group of devices 104 and the second group of devices 106 are not reconciled or synchronized with each other (i.e., separate GSDBs are maintained for the first group of devices 104 and the second group of devices 106). This is because device 104ₙ is the only device participating in both the first session 102₁ and the second session 102ₙ.

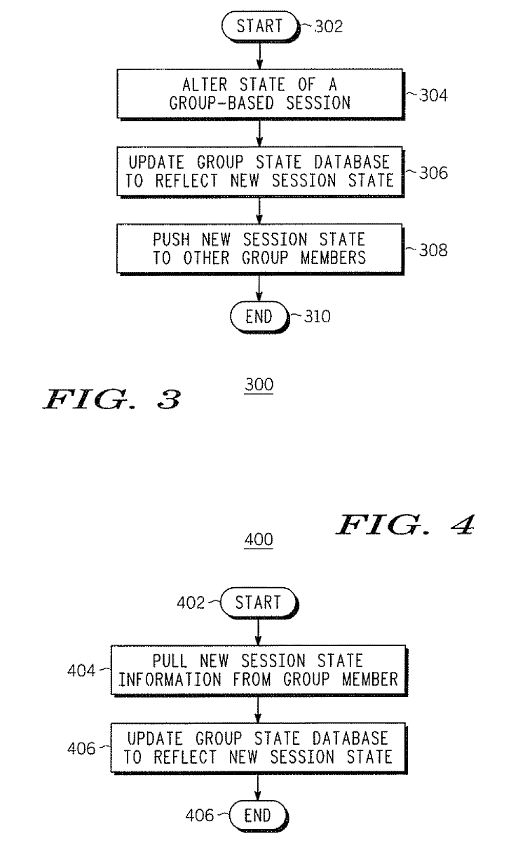

FIG. 3 is a flow diagram illustrating a first embodiment of a method 300 for synchronizing a group state database across a group of devices. The method 300 may be implemented, for example, at a member of a group, where the member is altering the state of a group-based session.

The method 300 is initialized at step 302 and proceeds to step 304, where the method 300 alters the state of the group-based session. For instance, referring back to FIG. 2, suppose member Xₙ of Group X has paused Service A.

In step 306, the method 300 updates the local copy of the GSDB to reflect the new session state (i.e., in light of the alteration made in step 304). For instance, referring again to FIG. 2, the GSDB 200 will be updated to reflect the paused state of Service A at time t, by member Xₙ.

The method 300 then proceeds to step 308 and pushes the new session state to the other members of the group. For instance, referring to FIG. 2, the new session state will be pushed from member Xₙ to members X₁-Xₙ₋₁. As described in further detail below with respect to FIG. 4, this enables the other group members to synchronize their local copies of the GSDB such that the local copies maintained by all members of the group reflect the same up-to-date information. The method 300 then terminates in step 310.

Synchronization of the GSDB between member devices thus occurs without the intervention or awareness of a centralized entity, such as a server. However, a centralized server may participate in the group state and may contain a copy of the group's GSDB. Sessions are negotiated for the group as a whole, and all of the attributes of a given session thus apply to the group as a whole (rather than to individual members of the group). It will be appreciated, however, that all members of a group may not be capable of participating in a given session in a like manner. If a particular member device of a group is incompatible with a particular service, the user of the member device may be alerted to this fact and given the option to activate the session on the member device in a degraded state (e.g., by receiving only a subset of the content associated with the session) or to not activate the session at all.

FIG. 4 is a flow diagram illustrating a second embodiment of a method 400 for synchronizing a group state database across a group of devices. The method 400 may be implemented, for example, at a member of a group, where a session in which the group participates has been altered by another member of the group.

The method 400 is initialized at step 402 and proceeds to step 404, where the method 400 pulls new session state information from another group member that has altered the state of a group-based session. For instance, as described above with respect to FIG. 3, the other group member may have paused the state of the group-based session.

In step 406, the method 400 updates the local copy of the GSDB to reflect the new session state. Thus, the group member at which the method 400 executes now has a synchronized, up-to-date view of the state of the group and of sessions in which the group participates. The method 4090 then terminates in step 408.

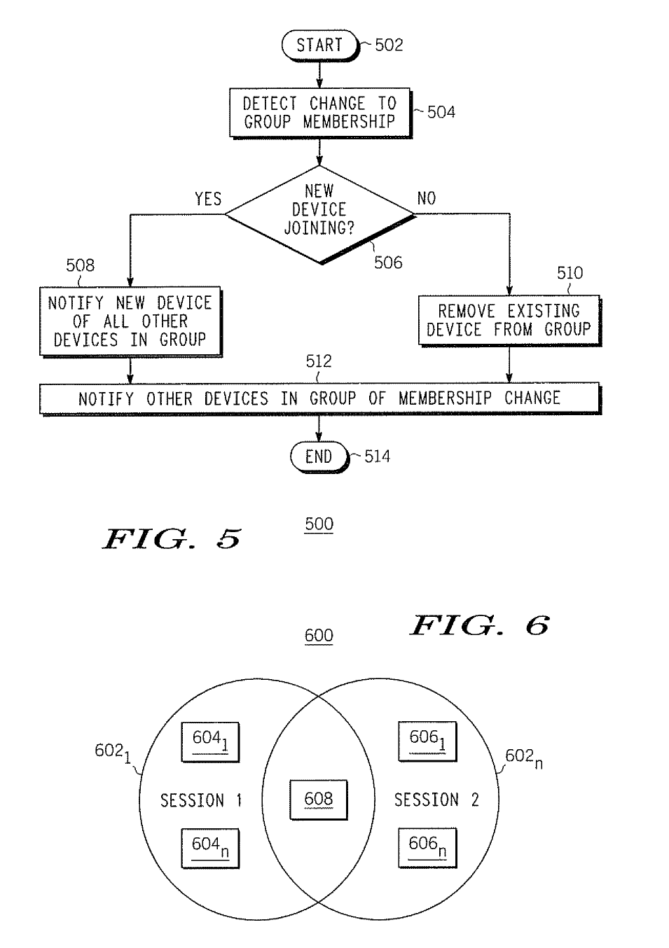

FIG. 5 is a flow diagram illustrating one embodiment of a method 500 for registering devices as members of a group. The method 500 may be implemented, for example at a network logical element that maintains a directory of user devices making up a group, such as a server (e.g., a lightweight directory access protocol (LDAP) or remote authentication dial in user service (RADIUS) server). In one embodiment, the directory contains subscription information about the user devices, the locations of the user devices, and the services that the user devices can render.

The method 500 is initialized at step 502 and proceeds to step 504, where the method 500 detects a change to the membership of a group. The change may be a new device joining the group or an existing device leaving the group.

In step 506, the method 500 determines whether the detected change is a new device joining the group. If the method 500 concludes in step 506 that a new device is joining the group, the method 500 proceeds to step 508 and notifies the new device of all of the other devices in the group (e.g., by transmitting the current GSDB to the new device).

Alternatively, if the method 500 concludes in step 506 that a new device is not joining the group, the method 500 assumes that an existing device is leaving the group and proceeds to step 510, where the existing device is removed from the group.

In step 512, the method 500 notifies the other members of the group of the change in group membership (whether the change is the addition of a new device in step 508 or the removal of an existing device in step 510). The method 500 then terminates in step 514.

In one embodiment, devices that power-on/power-off are re-registered each time they power-on for the purposes of the method 500. In a further embodiment, such devices are removed from the group each time they power-off. Thus, the remaining group members will not need to track a device that has been powered-off.

In one embodiment, the method 500 may be practiced within the context of network server-based directory management. FIG. 6, for example, is a conceptual diagram illustrating an exemplary network 600 in which one or more sessions 602₁-602ₙ (hereinafter collectively referred to as “sessions 602”) take place. In the illustrated embodiment, a first group of devices (or a mix of devices and applications) 604₁-604ₙ (hereinafter collectively referred to as “first group of devices 604”) participate in a first session 602₁ (e.g., a streaming video session), while a second group of devices (or a mix of devices and applications) 606₁-606ₙ (hereinafter collectively referred to as “second group of devices 606”) participate in a second session 602ₙ (e.g., a push-to-talk communication session). The first session 602₁ and the second session 602ₙ operate independently of each other.

The network 600 further comprises a server-based directory manager 608 through which sessions can be established. For instance, if a new device (not shown) wishes to join the first group of devices 604, the new device will interact with the directory manager 608 to discover its peers in the first group of devices 604 (i.e., devices 604₁ and 604ₙ). The new device may communicate with its peers directly after discovering the peers from the directory manager 608, and then all members of the first group of devices 604 (i.e., the new device and original devices 604ᵢ and 604ₙ) can update their GSDBs, for example in accordance with the methods 300 and 400 described above. When a group member leaves the group (e.g., powers off), the remaining group members may detect the loss of the leaving member by maintaining a “keep alive” protocol and a timer.

The methods of the present invention, and particularly the group state database described herein, may be applied to a plurality of use cases, including session transfers and session parking.

For instance, a user who has gained access to a session may wish to transfer the session from a first device to a second device in the same group (“session transfer”). The present invention enables such a transfer in a substantially seamless manner, so that the transferred session can be resumed, intact, on the second device. Initiation the transfer by the first device (e.g., by sending the transferred session to the second device) is called a “push”, while initiation of the transfer by the second device (e.g., by requesting the transferred session from the first device) is called a “pull”. Push and pull transfers have rules associated therewith. For example, if another user is using the device to which the session is pushed (e.g., the second device in the present example) and thus rejects or otherwise blocks the transfer, the user requesting the transfer will typically be notified.

The session transfer case can also be extended to include the device presence concept. For instance, referring back to FIG. 1, the user may be watching a news program (session) on a large screen television (first device 104₁) at home. If the user needs to leave home before the news program is over, he or she may wish to push the news program to a handheld device (second device 104₂) for later viewing. This transfer may be mediated by a residential gateway (third device 104ₙ). The second device 104₂ to which the news program is pushed includes an application (either native or downloaded as a service) that allows the second device 104₂ to join and participate in the group with which the first device 104₁ is associated. In this case, the concept of presence, in conjunction with the availability of the session state, makes it possible for the seamless transfer of the news program from the large screen television to the handheld device.

In another example, user who has gained access to a session may wish to suspend a session on a first device (“session parking”). In this case, the suspended session will be pulled by the next requesting device (e.g., a second device). In accordance with the present invention, the length of time for which the session is parked before expiration notifications are sent to other group members is configurable. Once such notification is sent, the other group members may request continuation of the suspended service at the point where the service was suspended. As an example, if the service were a “linear video service”, such as a real time broadcast video, the user could pause the service, and then resume the service from the PAUSE point, FAST FORWARD (FF) to the current real time service time, or REWIND (RWND) to some point in the service to the beginning or to some operator-defined timeframe based on service availability.

The methods of the present invention also allow users to share membership between devices. For instance, a first user may enter the home of a second user and wish to participate in a session of which the second user's device (e.g., personal computer) is a participant. In this case, the first user would grant access to the relevant group membership (i.e., access to the GSDB) on the second user's device (e.g., a personal digital assistant). Once the second user's device has access to membership within the group, and within any constraints of the functionality the first user permits, the second user will be able to participate within the group and control the session via his or her device.

The processes shown in FIGS. 2-5 may be implemented in a general, multi-purpose or single purpose processor. Such a processor will execute instructions, either at the assembly, compiled or machine-level, to perform that process. Those instructions can be written by one of ordinary skill in the art following the description of FIGS. 2-5 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

FIG. 7, for instance, is a high level block diagram of the present session maintenance method that is implemented using a general purpose computing device 700. In one embodiment, a general purpose computing device 700 comprises, as generally described above, a processor 702, a memory 704, a session maintenance module 705 and various input/output (I/O) devices 706 such as a display, a keyboard, a mouse, a modem, a network connection and the like. In one embodiment, at least one I/O device is a storage device (e.g., a disk drive, an optical disk drive, a floppy disk drive). It should be understood that the session maintenance module 705 can be implemented as a physical device or subsystem that is coupled to a processor through a communication channel.

Alternatively, as also discussed above, the session maintenance module 705 can be represented by one or more software applications (or even a combination of software and hardware, e.g., using Application Specific Integrated Circuits (ASIC)), where the software is loaded from a storage medium (e.g., I/O devices 706) and operated by the processor 702 in the memory 704 of the general purpose computing device 700. Additionally, the software may run in a distributed or partitioned fashion on two or more computing devices similar to the general purpose computing device 700.

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While the foregoing is directed to embodiments of the invention, other and further embodiments of the invention may be devised without departing from the basic scope thereof.

What is claimed is:

1. A method for maintaining a user session across a group comprising a plurality of user devices, the method comprising:
altering, at a first device in the group, a state of the user session, such that a new session state results; and
transferring the new session state from the first device to at least one of the plurality of user devices in the group.

2. The method of claim 1, wherein the transferring comprises:
pushing the new session state from the first device to the at least one of the plurality of user devices.

3. The method of claim 1, wherein the transferring comprises:
pulling the new session state from the first device to the at least one of the plurality of user devices.

4. The method of claim 1, further comprising:
updating, at the first device, a local copy of a group state database to reflect the new session state.

5. The method of claim 4, wherein the group state database comprises current session state for the group.

6. The method of claim 4, wherein each of the plurality of devices maintains a local copy of the group state database, each local copy being synchronized with other local copies.

7. The method of claim 4, wherein the group state database comprises an entry for each of the plurality of devices, each entry comprising, for a given device, at least one of: a group member ID associated with the given device, a device ID associated with given device, a user ID associated with the given device, an exception associated with the given device, a rule associated with the given device, a session to which the plurality of devices is currently subscribed, a current state of the session to which the plurality of devices is currently subscribed, a time as of which a state of the session to which the plurality of devices is currently subscribed went into effect, a state transition time as of which a state of the session to which the plurality of devices is currently subscribed went into effect, a last one of the plurality of devices to change the state of the session to which the plurality of devices is currently subscribed, a location of the given device, and a service that the given device can render.

8. A computer readable medium containing an executable program for maintaining a user session across a group comprising a plurality of user devices, where the program performs the steps of:
altering, at a first device in the group, a state of the user session, such that a new session state results; and
transferring the new session state from the first device to at least one of the plurality of user devices in the group.

9. The computer readable medium of claim 8, wherein the transferring comprises:
pushing the new session state from the first device to the at least one of the plurality of user devices.

10. The computer readable medium of claim 8, wherein the transferring comprises:
pulling the new session state from the first device to the at least one of the plurality of user devices.

11. The computer readable medium of claim 8, further comprising:
updating, at the first device, a local copy of a group state database to reflect the new session state.

12. The computer readable medium of claim 11, wherein the group state database comprises current session state for the group.

13. The computer readable medium of claim 11, wherein each of the plurality of devices maintains a local copy of the group state database, each local copy being synchronized with other local copies.

14. The computer readable medium of claim 11, wherein the group state database comprises an entry for each of the plurality of devices, each entry comprising, for a given device, at least one of: a group member ID associated with the given device, a device ID associated with given device, a user ID associated with the given device, an exception associated with the given device, a rule associated with the given device, a session to which the plurality of devices is currently subscribed, a current state of the session to which the plurality of devices is currently subscribed, a time as of which a state of the session to which the plurality of devices is currently subscribed went into effect, a state transition time as of which a state of the session to which the plurality of devices is currently subscribed went into effect, a last one of the plurality of devices to change the state of the session to which the plurality of devices is currently subscribed, a location of the given device, and a service that the given device can render.
